(19) United States
(12) Patent Application Publication
(10) Pub. No.: US 2005/0213343 A1
(43) Pub. Date: Sep. 29, 2005

(54) Novelty device

(75) Inventor: Xavier Andrew Jablonski, Newport (AU)

Correspondence Address: OLIFF & BERRIDGE, PLC, P.O. BOX 19928, ALEXANDRIA, VA, 22320, US

(73) Assignee: Xavier Andrew JABLONSKI, Newport (AU)

(21) Appl. No.: 11/047,581

(22) Filed: Feb. 2, 2005

Related U.S. Application Data
(63) Continuation of application No. PCT/AU03/00982, filed on Aug. 1, 2003.

(30) Foreign Application Priority Data
Aug. 2, 2002 (AU) 2002950564

(51) Int. Cl. F21V 7/04

(52) U.S. Cl. 362/602

(57) ABSTRACT

A novelty device including: a light guide which channels light whilst allowing a portion of the light to be emitted along at least part of the length of the light guide; detection means for detecting sound; and illumination means for illuminating the light guide; wherein the illumination means operates to illuminate at least part of the light guide based on the detection of sound by the detection means.

### FIELD OF THE INVENTION

The present invention broadly relates to an interactive novelty device. It relates particularly, though not exclusively, to an interactive bracelet or necklace that entertains the user and those around by its illumination.

### BACKGROUND TO THE INVENTION

Toys and novelty articles that light up and produce interesting colours have always fascinated both children and adults.

One such novelty article is known as a glow or light stick. The stick consists of a tube having a flexible plastic outer tube and a brittle inner tube. A first liquid is maintained within the inner tube and a second liquid between the outer and inner tubes. When the tubes are bent, the inner tube breaks, thereby allowing the two liquids to mix and cause a chemical reaction that makes the stick produce a bright florescent glow. If the stick is sufficiently flexible, it can be placed around a user as a bracelet or band to provide jewellery that glows in the dark. These sticks have a limited novelty value, with the glow gradually fading away somewhere between four and twelve hours after activation. The stick cannot be re-activated and is essentially a single use item.

U.S. Pat. No. 6,050,695 describes a pair of jewellery items, such as rings or lockets, which light up when in proximity to one another.

It is to be noted that this discussion of the background to the invention herein is included to explain the context of the invention. It is not to be taken as an admission that any of the material referred to was published, known or part of the common general knowledge as at the priority date of any of the present claims.

An object of the present invention is to provide a new type of novelty device that is entertaining and fun to use, manipulate and wear.

### SUMMARY OF THE INVENTION

A first aspect of the invention relates to a novelty device including:
a light guide which channels light whilst allowing a portion of the light to be emitted along at least part of the length of the light guide;
detection means for detecting sound; and
illumination means for illuminating the light guide;
wherein the illumination means operates to illuminate at least part of the light guide based on the detection of sound by the detection means.

One particular advantage of the invention is the entertainment value created by the interaction between sound and light. This interaction keeps users enthralled and provides for an interesting and interactive novelty device which is far less likely to loose its appeal than the static and un-reactive glow-sticks provided in the prior art.

Preferably, the illumination means operates to illuminate the light guide when sound is detected above or below a pre-determined volume level, frequency threshold or within a predetermined range. One form of the invention includes an adjusting means for adjusting the volume level, frequency threshold or pre-determined range. This allows the user to tune the device so that it reacts to specific sounds. Where there is a large amount of background noise then the adjusting means may be set at a relatively high level such that the device is not constantly illuminated. Where there is little background noise, the adjusting means may be tuned by the user so that the device reacts to even the slightest noise thereby picking up soft sounds such as whispers and the like.

The illumination means may illuminate the light guide at any suitable intensity. This intensity may be constant such that when illumination occurs then it occurs at a pre-determined intensity. In one optional form of the invention, the light guide of the device is illuminated at an intensity dependant on volume level or frequency of sound detected. The light guide may be illuminated at an intensity that is proportional to the volume level or frequency of sound detected by the detection means. The intensity of the illumination may optionally be related to the degree to which the volume level or frequency of a detected sound exceeds a threshold value. In one form of the invention, it includes means for adjusting the illumination intensity for a pre-determined volume level, frequency threshold or pre-determined range. Providing illumination of a variable intensity provides the novelty device with a further interesting and entertaining feature. For example, when a user shouts or talks loudly in the vicinity of the device then it will glow or illuminate brightly, whilst when a user speaks softly, the device will glow or illuminate with a relatively low intensity.

The pre-determined frequency threshold can be programmed to detect a pre-determined frequency or range of frequencies. The novelty device may, for example, operate to detect multiple pre-set or variable frequencies. This allows the novelty device to differentiate between bass, treble and other frequencies. For example, upon detection of a bass frequency, the illumination means operates to illuminate the light guide in a first manner (for example, in a first colours) whilst, upon detection of a treble frequency, the illumination means operates to illuminate the light guide in a second manner (for example, in a second colour). Where both bass and treble frequencies are detected then the illumination means may operate to illuminate the light guide in a combination of both the first and second colour. This allows the device to provide an accurate visual expression of sounds in the vicinity of the device.

The device may optionally provide means for adjusting the sensitivity of the detection means. This allows a user to adjust the sensitivity of the device to accord with its surroundings. For example, in a high noise environment, the user may decrease the sensitivity of the detection means so that it effectively ignores background noise. This adjustment of sensitivity can be utilised to prevent saturation of the monitoring circuits so that the light guide is not continuously illuminated.

The light guide can be constructed from any suitable material which channels light whilst allows at least some of that light to be emitted from along its length. Preferably, the light guide is an optic fibre cable.

The inventor has found that one particularly suitable type of light guide consists of a fibre optic cable that includes microscopic irregularities along the length of the cable thereby disturbing the internal refraction of light to ensure that the light is emitted from the cable along its length. One suitable cable is multi-stand cable that has multiple independent strands with a clear sheath. Another suitable cable is a solid light guide or light pipe formed from a solid flexible polymer that incorporates microscopic fragments of glass and other particles along its length that distribute light. The light is effectively channelled through the cable with the various particles along its length causing the light to disperse in direction other than the along the length of the cable.

The light guide may be of any suitable thickness. Light guides of around 5 and 10 mm in diameter have been found to be particularly suitable for use with the present invention. It is preferable that the light guide be flexible although it could be of a rigid material if necessary.

It should also be understood that each novelty device may include one or more light guides. A particular advantage of using a light guide is that it may be illuminated along its length without the need for electronic components being present within the light guide. The light is reflected through the material due to the nature of the material. It is particularly preferable that the light guide be of a material that can be easily cut or severed by user without any danger to the user and without compromising the function of the novelty device. Where, for example, the user wishes to reduce the length of the light guide, they may easily cut the light guide to remove a portion without affecting or damaging the functioning of the novelty device.

The illumination means may be placed in any suitable position within the device such that it illuminates the light guide. Preferably, the illumination means is placed in abutment or close proximity to at least one end of the light guide thereby directing light into the light guide.

Any suitable illumination means may be used with the present invention. One particularly preferred illumination means is a light emitting diode (LED). The means for illuminating may also consist of: two light emitting diodes with one light emitting diode in close proximity to each end of the light guide; or four light emitting diodes with two light emitting diodes in close proximity to each end of the light guide. In one further form of the invention, the LED's are such that the wavelength (and consequently colour) of light emitted from the LED can be modified so that the LED emits light of a different colour.

The illumination means is preferably capable of illuminating the light guide with light of at least two different colours. The illumination means may illuminate one part of the light guide in a first colour and a second part of the light guide in a second colour different from the first colour. The light guide may optionally be illuminated in the first colour and the second colour simultaneously to provide a part of the light guide that is illuminated in a colour formed by a mixture of the first and second colours. This increases the interest of the device; the device now provides interactions between sound, light and colour. The different colours within the light guide may either mix together to form a single combined colour. Alternatively, the light guide may display two or more colours in different parts of the one light guide.

The means for illuminating may include a first illumination means and a second illumination means wherein, the first illumination means operates upon detection of sound at a first sound characteristic and the second illumination means operates upon detection of sound at a second sound characteristic. This allows for operation of two illumination means either together or independently. Those illumination means may be responsible to any suitable sound characteristic, for example, the sound characteristic for each of the first and/or second illumination means may be one of a pre-determined volume, a pre-determined frequency, a range of pre-determined volumes and a range of pre-determined frequencies. The novelty device may similarly operate with four or more illumination means.

In another alternative or additional form of the invention, the illumination means operates to make the whole of the light guide glow. Preferably, the light guide is illuminated in a plurality of colours simultaneously to provide a part of the light guide that is illuminated in a colour formed by a mixture of colours. The novelty device may include an illumination means that utilises four or more wavelengths of light.

In still another form of the invention, there is provided a novelty device wherein, the means for illuminating includes a first illumination means, a second illumination means, a third illumination means and a fourth illumination means wherein each of the first, second, third and/or fourth illumination means operates upon detection of sound and/or frequency above, below or at a first, second, third and/or fourth respective pre-determined threshold level. Either one or more of the first, second, third and fourth illumination means operate either together or independently of each other. Two or more of the first, second, third and fourth illumination means may also be configured to operate in sequence. Additionally or alternatively, two or more of the first, second, third and fourth illumination means may operate in a pre-programmed sequence.

Where first, second, third and fourth illumination means are provided then the device may optionally include means for adjusting one or more of the first, second, third or fourth pre-determined threshold level.

The invention may also include means for selecting operation of one or more of the illumination means either together or individually. This means may, for example, dictate that sounds will alternatively illuminate each of the first, second, third and fourth illumination means in turn. Each of the illumination means may operate in a programmed or pre-selected manner. For example, when a sound is detected then the first illumination means will react illuminating the light guide, when the next sound is detected then the second illumination means will react to illuminate the light guide whereby each illumination means operates in turn. The illumination means may also operate in sequence when only two illumination means are present in the device.

A still further form of the invention, it relates to a novelty device wherein, the light guide is illuminated at a first intensity when sound is detected at a first sound level and illuminated at a second intensity when sound is detected at a second sound level, wherein when the second sound level is less than the first sound level then the first intensity is greater than the second intensity.

Preferably, upon the detection of sound, the illumination means operates to illuminate the light guide according to a pre-set program. Where this occurs, it is preferable that the novelty device further includes means for adjusting or selecting the pre-set program. Where any one or more of a first, second, third or fourth illumination means are provided, these can likewise operate to illuminate the light guide according to their own pre-set programs of or an overall program when sound is detected.

In another form of the invention, the device is continually illuminated and upon the detection of a sound characteristic, the illumination means reduces illumination of at least part of the light guide. In another form of the invention, the device is illuminated and upon the detection of sound, the illumination means reduces illumination of at least part of the light guide. When the sound is detected the light guide will appear either dim or turned off. When the sound ceases then the light guide may return to a state of illumination.

The novelty device may be a personal adornment device. In that instance then the device is particularly suitable for wearing as a bracelet or necklace.

A novelty device according to the present invention may be constructed in any suitable manner. Preferably, the means for detecting sound includes a microphone. Preferably, the invention includes a micro-processing means to control interaction between the detection means and the illumination means. The novelty device may optionally include a control unit for housing the detection means and the illumination means. In one particularly preferred form of the invention, the control unit is coupled to an end of the light guide. Most preferably, the control unit is coupled to each end of the light guide.

In one form of the invention, a coupling means is attached to an end of the light guide. This coupling means may mate with the control unit to allow the user to releasably couple the light guide and the control unit. The coupling means also assists in maintaining a secure connection between the light guide and the control unit.

The novelty device may include two control units with one control unit at each end of the light guide. The novelty device may also include more than two control units. In one preferred form, the novelty device includes two light guides with each of the ends of the light guide are coupled to a control unit in a circular configuration. Each of the control units may operate upon the detection of sound at a different sound level or frequency.

In still another form of the invention, the control unit is releasably coupled to the light guide. The control unit may optionally include at least one socket for releasably receiving an end of the light guide. A socket may be provided at opposed ends of the control unit to receive an end of the light guide. In another form, the light guide may have a suitable clip attached to its end to allow coupling with the control unit. It is preferred that the novelty device be readily detachable from the light guide so that the user may connect, detach and re-connect the control unit as desired. This versatility allows the user to create a number of configurations which utilise one or more control units together with one or more light guides. The releasablility of the control unit (which houses the illumination means and preferably the detection means) provides the user with a modular unit which can be connected to a light guide of any suitable length or configuration. This allows the user to build their own device that includes a number of control units interconnected by light guides. In turn this allows the user to create a device having a wide variety of shapes. This also allows the user to interchange control units to produce different colour combinations within each of the light guides.

The light guide may be formed from either a flexible or rigid material. It is however preferred that the light guide be formed from a flexible material. The use of a flexible material is particularly advantageous in that it allows the user to bend the light guide into a range of suitable shapes. The user may present the light guide in a circular configuration. He/She may also manipulate the light guide(s) to form a figure of eight configuration. When placed in the figure of eight configuration, the device may be worn around the eyes in a similar manner to a pair of large novelty glasses or mask.

In another form of the invention, the novelty device operates upon detection of sound with the illumination means operating to illuminate the light guide according to a pre-set program. The device may include means for adjusting or selecting the pre-set program.

The novelty device of the present invention may form part of another device. For example, it may be incorporated into a portable radio or other sound emitting device.

In a second aspect of the invention, there is provided a personal adornment device, including a light guide which channels light whilst allowing a portion of the light to be emitted along at least part of the length of the light guide; a control unit coupled to the light guide, the control unit including illumination means for illuminating, wherein the illumination means directs light into the light guide according to a pre-determined program.

Preferably, the control unit is releasably coupled to the light guide to allow a user to attach and detach the light guide from the control unit.

The personal adornment device may further includes, means for detecting sound, wherein in a coupled state and upon detection of sound the means for illuminating is activated to direct light into the light guide.

The light guide may optionally be a flexible strip element. In another alternative or additional form of the invention the light guide is arranged in a circular configuration or figure of eight configuration. Preferably, each end of the light guide is coupled to the control unit or units.

In a third aspect of the invention, there is provided a novelty device including at least one control unit, the control unit including:
coupling means for releasably coupling the control unit to one or more light guides;
illumination means for illuminating a light guide when the control unit and the light guide are in a coupled state, the means for illuminating operating to direct light into the light guide whereby light is directed through the light guide and emitted along at least part of the length of the light guide.

Preferably, the control unit is configured to releasably receive an end of the light guide. In a preferred form, the control unit is configured to releasably receive both ends of the light guide to display the light guide in a circular configuration.

The control unit may include detection means for detecting sound electrically connected to the illumination means wherein the illumination means operates to illuminate at least part of the light guide based on the detection of sound.

In a fourth aspect of the invention, there is provided a novelty device including:
a set of illumination units;
one or more light guides; wherein each of the illumination units includes one or more sockets for releasably receiving an end of the light guide.

Another particular advantage of the present invention is the entertainment value created by the interaction of a plurality of control units (each incorporating an illumination means). These can be joined together to act either independently or together. The modular nature of the control units allows for great scope in the number of light guides and control units that can be combined together in the one device.

In a fifth aspect of the invention, there is provided a novelty device including:
a light guide which channels light whilst allowing a portion of the light to be emitted along at least part of the length of the light guide;
illumination means for illuminating the light guide, including
   first illumination means for directing light of a first wavelength through the light guide;
   second illumination means for directing light of a second wavelength through the light guide; wherein the first and second wavelengths are different wavelengths.

Preferably, the device further includes detection means for detecting sound wherein the first and/or second illumination means operate based on the detection of sound.

The one of the first and second illumination means may optionally operate based on the detection of sound and the other one of the first and second illumination means operates based on a pre-determined program.

In one form of the invention, the first illumination means is responsive upon detection of a first sound characteristic and the second illumination means is responsive upon detection of a second sound characteristic.

In a fifth aspect, the present invention relates to a portable novelty device, including:
one or more strip elements;
one or more control units, wherein each control unit includes:
   illumination means for illuminating the strip element;
   coupling means for releasably coupling the control unit to one or more strip elements in a modular configuration.

Preferably, the strip element is a light guide that allows for channelling of light whilst allowing a portion of the light to be emitted along at least part of the length of the light guide.

In one form of the invention, two control units are connected by strip elements forming a circular or figure of eight configuration suitable for wearing around a body part of a user.

In a sixth aspect of the present invention, there is provided an illuminated portable novelty device, including:
a flexible light guide;
illumination means for illuminating the light guide;
wherein the illumination means operates to illuminate at least part of the light guide to give a glowing appearance when activated by a pre-determined program.

In a seventh aspect of the present invention, there is provided a sound emitting electronic device, including:
a light guide which channels light whilst allowing a portion of the light to be emitted along at least part of the length of the light guide; and
illumination means for illuminating the light guide in response to sound emitted from the sound emitting electronic device;
wherein the illumination means operates to illuminate at least part of the light guide based on the detection of sound by the sound emitting electronic device.

Preferably, the light guide is an optical fibre.

It should be understood that all aspects of the present invention may have all the optional features described under the first aspect of the invention. It should also be understood that the novelty device of the present invention may be responsive to a pre-determined frequency, range of frequencies as well as a pre-determined volume level or range of volume levels.

It should also be emphasised that whilst many of the embodiments of the present invention are portable, it is not necessary that the novelty device necessarily be portable and that it could be fixed to any suitable structure or other device.

### BRIEF DESCRIPTIION OF THE DRAWINGS

The invention will hereinafter be described in greater detail by reference to the attached drawings, which illustrate example forms of the invention. It is to be understood that the particularity of the drawings does not supersede the generality of the preceding description of the invention. In the drawings:

FIGS. 1 and 2 respectively illustrate front and rear perspective views of a device constructed according to the present invention.

FIG. 3 illustrates an exploded view showing the internal components of a novelty device constructed according to the present invention.

FIG. 4 illustrates a cut-away view of a device constructed according to an embodiment of the present invention.

FIGS. 5 to 8 illustrate various views of the circuit board and components mounted thereon.

FIG. 9 illustrates a device constructed according to the present invention, the device incorporating two control units.

### DETAILED DESCRITPION OF THE DRAWINGS

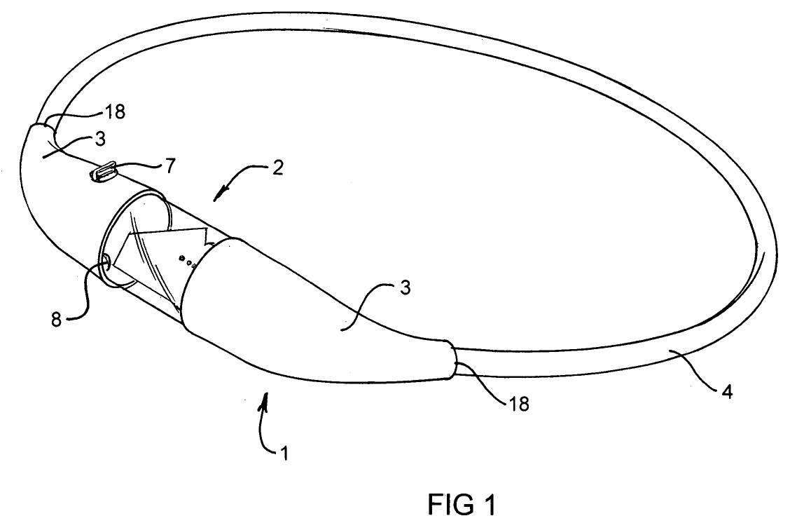

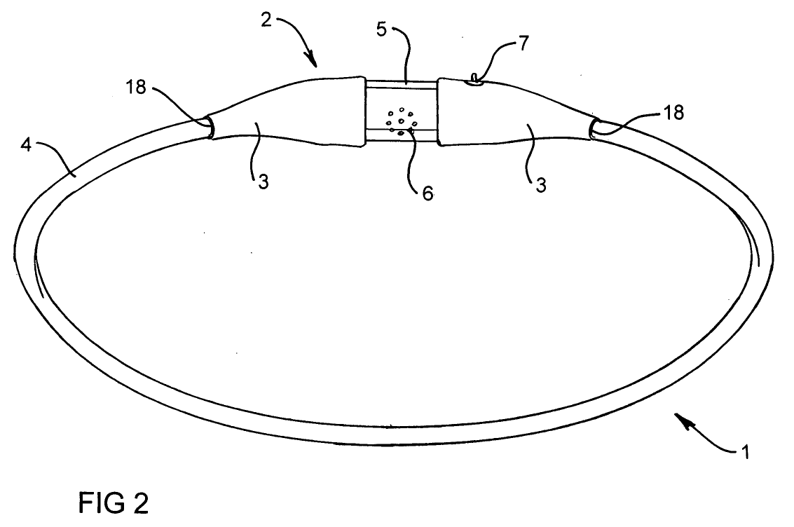

One particular embodiment of the present invention is illustrated in FIGS. 1 and 2. The device illustrated may be used as a bracelet or necklace. The device 1 includes a control unit 2 and a light guide in the form of a band 4. Preferably, both the control unit 2 and band 4 are portable and lightweight so that the device can be easily worn around an arm or neck of a user. The control unit 2 allows the user to control operation of the device. The control unit illustrated in FIGS. 1 and 2 operates on batteries although it should be understood that various embodiments of the invention operate by utilising alternative forms of power such as mains power. The control unit 2 includes a means for detecting sound and at least one means for illuminating the band. The control unit 2 is housed inside a central cylinder 5 with tapered ends 3 provided at each end of the cylinder. As shown in FIG. 2, an opening 6 is provided in cylinder 5 to allow sound to permeate into the housing, the housing stores the means for detecting sound. The central cylinder 5 has an opening to accommodate a switch 8 that interacts with the control unit thereby allowing the user to control operation of the device. The tapered ends 3 are shaped to receive an end of the band 4. The device may be provided with a tuning dial 7 that allows the user to adjust operation of the device, it can for example, be used to alter the sensitivity at which the means for detecting sound will operate.

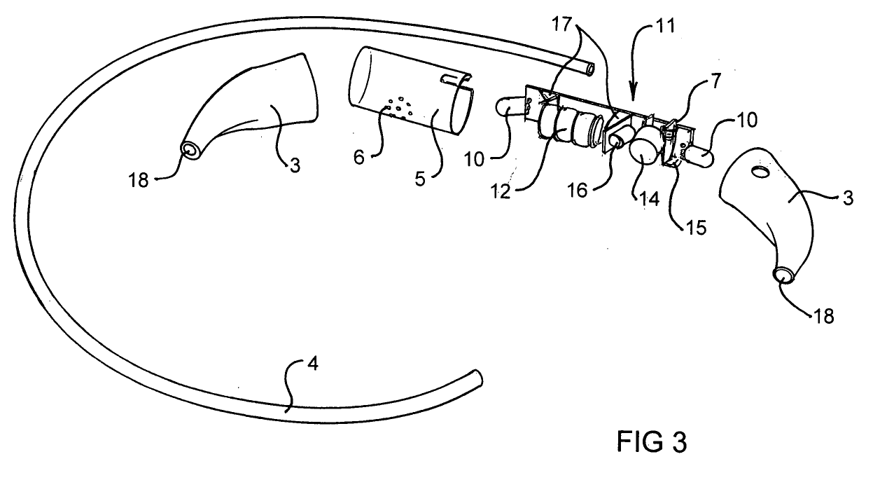

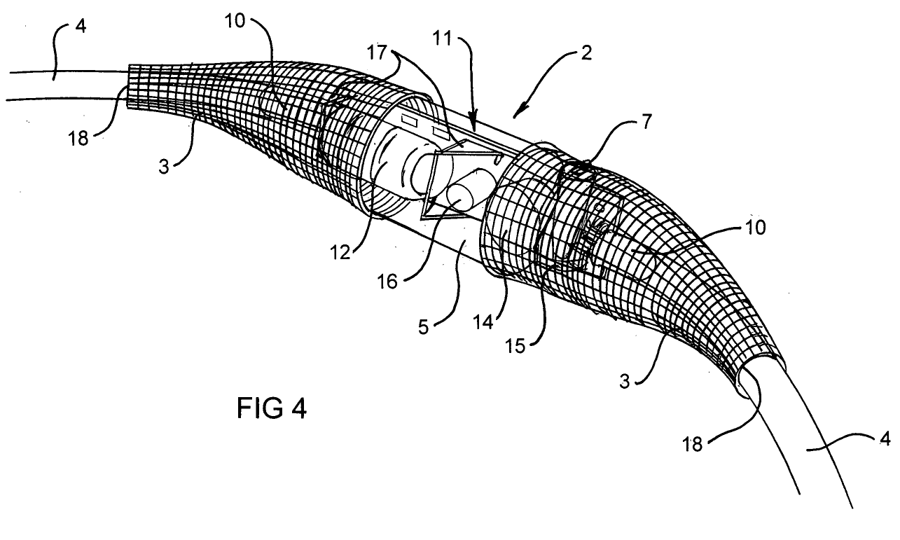

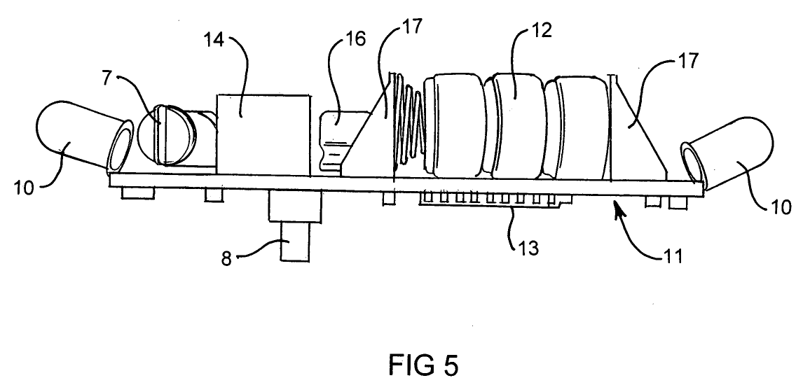

The various components, in respective exploded and cutaway forms, of a device constructed according to an embodiment of the present invention are shown in FIGS. 3 and 4. The central cylinder 5 and tapered ends 3 house the circuit board 11.

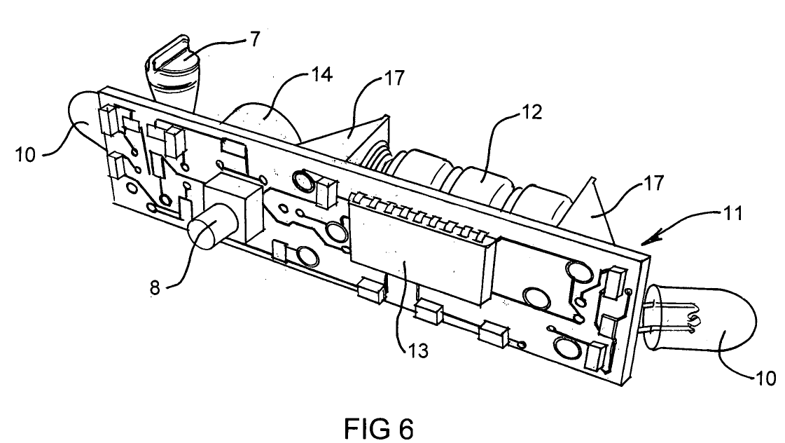

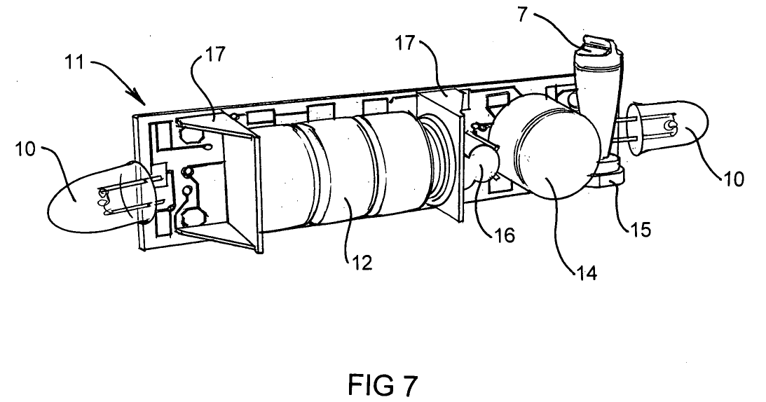

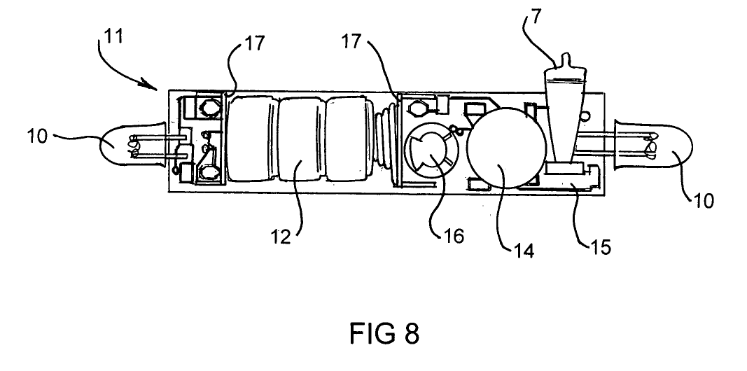

It will be understood that a circuit board can be used with the present invention in order that the particular components work together as defined by the present invention. A suitable circuit board with components attached thereto is illustrated in FIGS. 5 to 8. The circuit board 11 has a battery 12 connected thereto via battery clips contacts 17. On either end of the board there is placed two LED's 10 as well as a microprocessor 13, a microphone 14 and tuning dial 7. The device also functions with a potentiometer 15, a capacitor 16, switch 8 and a plurality of resistors and j-fetts.

In one particular form of the invention, the circuit board is a PCB board with the following components connected:
i. microphone;
ii. at least one LED. Preferably two or four or more;
iii. at least one microprocessor;
iv. at least one capacitor;
v. at least one resistor;
vi. at least one “J-Fett” (or minature amplifier)
vii. battery clips contacts;
viii. batteries;
ix. a switch; and
x. a potentiometer.

The means for detecting sound shown in this embodiment consists of a microphone 14. The means for illuminating consists of two light emitting diodes (LED) 10 although it should be understood that the invention may also function with a single LED or alternatively, three or more LED's. The microprocessor 13 is electrically connected to both the microphone 14 and each of the LED's 10. Upon detection of sound above a predetermined threshold level, the microprocessor 13 actives the LED's 10 to illuminate the band 4. This illumination occurs by placement of the LED in either abutment or close proximity to one end of the band, when the LED operates to emit light, the light is guided through the band to cause illumination along at least part of its length.

The device is particularly suitable for wearing around an extremity of the user such as the neck or arm. When sound is detected by the sound detecting means, the means for illumination operates to illuminate the band. The device provided by the present invention may be provided with a number of controls that give the wearer effective control so that he/she may dictate operation and interaction of the device with the various sounds around themselves.

In one embodiment, the switch 8 can be operated to turn the device on and off. In another embodiment the switch 8 acts as a mode selection button. When pressed once, the control unit turns on and begins operating in a first mode. When the mode selection button is pressed again, the device operates in another mode. The device will then scroll to the next mode each time the mode selection button is pressed, until it has scrolled through all of the modes at which time it returns to the first. The device may also be programmed so that when a user holds the mode selection button down for a pre-set time the control unit is turned off.

The device may optionally be provided with a tuning dial 7. This allows the user to adjust the device so that it differentiates between both high and low-level sounds. This provides the wearer with the ability to tune the device to any volume level or pitch until the desired effect is achieved. The device is illuminated when sound is detected above a pre-determined level or pre-determined frequency. When the wearer is located in a noisy environment, such as a rock concert, then the high volume background noise may saturate the means for detecting sound leading to constant illumination of the band. This may be avoided by operating the tuning dial to adjust the sensitivity of the sound detecting means. This will in turn reduce the flow of data to the microprocessor and allow the device to illuminate accurately as desired. The tuning dial (or tuning control) can be used to tune the device into various sounds despite background noise allowing the device to respond accurately to music or other sounds around the wearer. It should also be understood the tuning dial may any suitable means to control or tune the control unit. The tuning dial may, for example, consist of two buttons electronically linked to the micro processing means. The tuning dial may be used to adjust the pre-determined sound threshold. For example, the device can be adjusted so that the sound threshold is relatively low to detect even whispers or set relatively high so that it only detects shouting or other loud noises. Furthermore, the tuning dial may be adjusted so that it identifies noises of different volumes (or frequency) such that either low or high volume (or frequency) noises are only detected leading to illumination of the band. Additionally or alternatively, the turning dial may be set so that it only identifies noises within a range of volumes and/or frequencies.

In one particularly preferred embodiment, the device includes at least two LED's 10, these LED's may operate either together or independently. Where the LED's operate independently then there is a large number of combinations that may be adopted. For example, one LED may operate to illuminate upon detection of a low-volume sound while the other LED operates upon detection of a high-volume sound. The device may operate in a large number of different modes, for examples, it may operate in any one or more of the following modes where it is provided with two LED's:

(1) (1) First LED low and Second LED high. The first LED operates when sound is detected at either a low volume or high pitch (treble) while the second LED operates when sound is detected at either a high volume or low pitch (bass).

(2) First LED high and second LED low. The first LED operates when sound is detected at either a high volume or low pitch (bass) while the second LED operates when sound is detected at either a low volume or high pitch (treble).

(3) First LED high and second LED high. Both the first and second LED's operate when sound is detected at a high volume or low pitch (bass). Each LED can however be adjusted via the micro-processing means so that it operates at a different (volume or frequency) level.

(4) First LED low and second LED low or high pitch (treble). Both the first and second LED's operate when sound is detected at a low volume. Each LED may be adjusted so that it operates at a different (volume or frequency) level.

(5) First LED operating in sound sensitive mode reacting to low or high volume whilst the second LED is pre-set to act independently either ON or in a pre-programmed loop or flashing mode.

(6) First LED operating in sound sensitive mode at low volume/high pitch treble and the second LED is turned off.

(7) Second LED operating in sound sensitive mode at a low volume/high pitch treble and the first LED is turned off.

(8) First LED operates in a sound sensitive mode at a high volume/low pitch bass and the second LED is turned off.

(9) Second LED operates in a sound sensitive mode at a high volume/low pitch bass and the first LED is turned off.

(10) Sequence mode. When a first sound is detected the first LED will flash on then off. When the next sound is detected then the second LED will flash on. When a still further sound is detected both the fist and second LED's will flash on together. The program will then repeat.

The device of the present invention may also cycle through a number of modes that do not necessarily detect sound around the device, for example:

(11) Each of the first and second LED's in “FAST” strobe mode where both the first and second LED's operate to turn on and off as a strobe. The “FAST” signifying that the LED's turn on/off with a high frequency.

(12) First LED in FAST strobe mode. Second LED turned off.

(13) Second LED in FAST strobe mode. First LED turned off.

(14) “Cop sirens loop” mode where the LED's illuminate the band to give the appearance of the light travelling around the band.

(15) “Off-beat” FAST strobe where the LED's alternatively strobe so that when the first LED is on then the second LED is off (and visa versa).

(16) Both LED's fade in and fade out (in sync) loop. Both of the LED's fade in and out in a synchronised manner.

(17) First LED fades in and second LED fades out. Each LED fades in and out in turn. While one LED fades in, the other LED fades out.

(18) First LED fades in and out and the second fades in and fade out in a loop.

(19) First LED fades in and out, second LED is turned off.

(20) Second LED fades in and out, first LED is turned off.

(21) Off-beat flash (slow), each of the LED's flash at a low frequency.

(22) First LED on and second LED mid strobe. The second LED operates at a moderate recurring frequency.

(23) First LED on and second LED flashes at a high frequency.

(24) Second LED on and first LED flashes at a medium frequency.

(25) Both first and second LED flash at a medium frequency in synchronisation.

(27) Off-beat mid-strobe.

(28) Both first LED and second LED on.

(29) Second LED on and first LED off.

(30) First LED on and second LED off.

(31) Both first and second LED flash at a low frequency in synchronisation.

(32) Flash first to second to fast strobe loop.

(33) Fade in Fade out first to second to fast strobe loop.

The above modes show that that by utilising two LED's, a large number of variable modes can be used with the device of the present invention including sound sensitive and preset modes or a combination of both. The number of combinations is further increased when three, four or more LED's are utilised with the device.

The colours and lights illuminated from the device are particularly eye catching where the LED's emit lights of differing colours. Where two LED's are used then each of the LED's can be a different colour. This allows for the two colours to be mixed or blended displaying a third colour. For example, a combination of RED and BLUE gives purple; a combination of RED and WHITE gives PINK while a combination of GREEN and BLUE gives AQUA. Where the first and second LED's are set to the modes above then there can be an even greater combination of colours and lights.

For example, in mode (1) above where the first LED is red and the second LED is blue, low volume sounds will illuminate the device in the colour RED, high volume sounds will illuminate the device in the colour BLUE and a combination of both high and low volume sounds will illuminate the at least part of the device in a purple colour. The intensity of the LED's may also change the colour appearing. For example, where the first LED is operating at a greater intensity than the second LED then the PURPLE will have more of the RED colour component. Depending on the intensities of each of the LED's, there may also be a transition of colours along the band, for example, closer to the first LED the colour will be RED turning to PURPLE and BLUE closer to the second LED. The number of possible permutations and combinations is great. While any suitable combination of colours may be used, the inventor envisages that many of the following combinations can be used including the following colour combinations when using two LED's:
(a) RED-BLUE-PURPLE;
(b) RED-WHITE-PINK;
(c) RED-YELLOW-ORANGE;
(d) RED-GREEN-LIGHT ORANGE;
(e) BLUE-WHITE-LIGHT BLUE;
(f) BLUE-GREEN-AQUA;
(g) BLUE-YELLOW-LIGHT GREEN;
(h) YELLOW-WHITE-LIGHT YELLOW;
(i) GREEN-YELLOW-CANARY YELLOW;
(j) GREEN-WHITE-LIGHT GREEN.

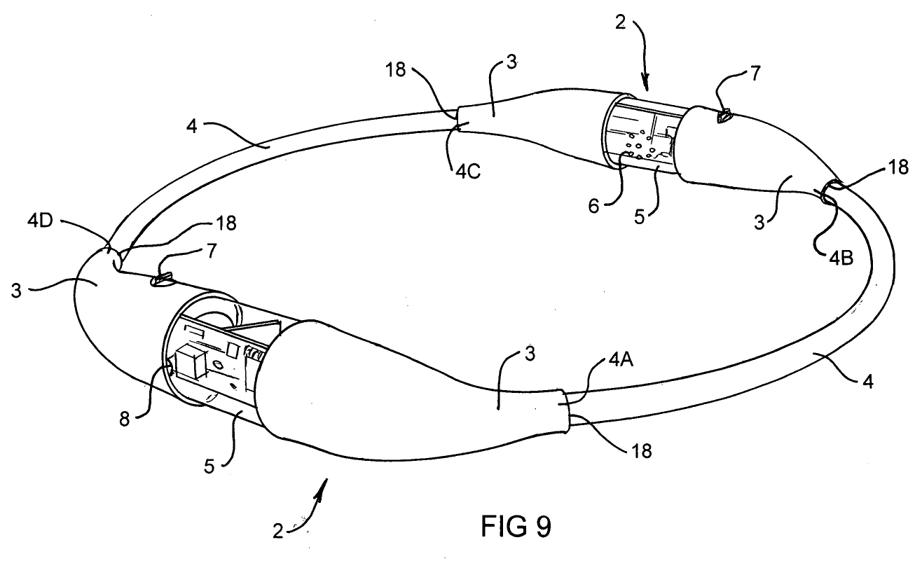

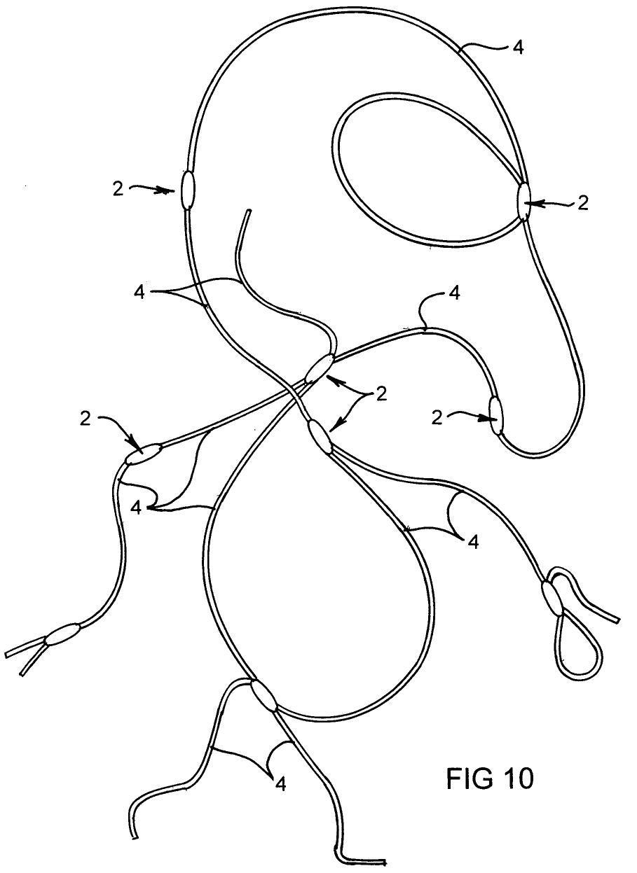

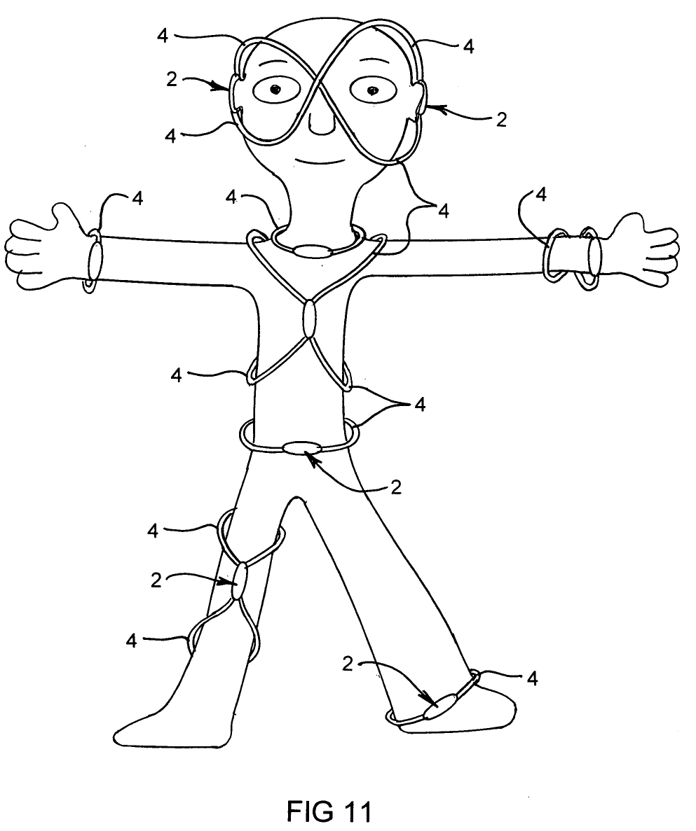

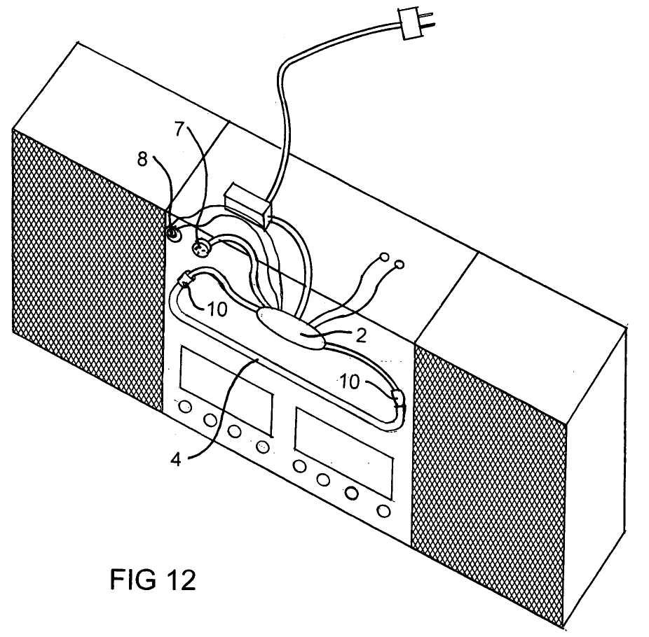

As discussed above, a user of the present invention can adjust the device so that it functions in various ways with a large number of reactions to various sounds. This effect can be further enhanced where two or more of the devices are connected together. An illustration of device incorporating two control units is included in FIG. 9, this device can be formed by joining two devices. A light guide 4 joins each of the control units 2. Each of the LED's in the first control unit illuminates the band at points 4A and 4D whilst the second control unit illuminates the band at points 4C and 4B. The colour spreads through the light guide as the LED's illuminate and, for example, in the light guide between points 4C and 4D, there is a combination of colours from each LED. The inventor has found that the colour blends and combinations created by the two joined devices are very attractive to the eye, particularly in low light conditions. One of the control units 2 may, for example, operate in a pre-set mode where it flashes according to a pre-set program while the other control unit operates in sound sensitive mode illuminating only when sound is detected at a pre-tuned threshold. The colour blends and combinations created by the two or more control units provides an interesting light show for the user and those around him or her.

Where two devices are joined then further variations in the interactivity of the devices can be achieved by re-joining the devices in a different combination. This can be done by flipping one of the devices 1800 and rejoining. For example, with reference to FIG. 9, one of the control units 2 can be un-attached and re-attached so that the connections at positions 4A and 4D are exchanged.

Furthermore, where two or more control units are available to a user, the ability to join the multiple devices in various configurations (other than a basic circle) offers additional versatility and entertainment. For example, if two control units are joined together, the light guide can be crossed to form a figure of eight configuration. This configuration can be explained by reference to FIG. 9, when a figure of eight device is created (not shown), a first light guide 4 would be extend from 4A to 4C and the second light guide would extend from 4D to 4B, inturn each light guide 4 would cross over or under the other creating a figure eight formation. Further interesting combinations may be achieved by joining even further control units together, for example, four control units could be joined to form a large circular type configuration.

The present invention has a wide variety of applications. Placed around the wearer's neck, it will follow the wearer's voice, lighting up when the wearer makes a sound. This can be ideal for having “night chats” with friends in the dark. Doubled around the wearer's wrist makes it appear as a space age communication device when playing STAR TREK™ or STAR WARS™ games. Configured to a figure eight using two control units, the device can be hooked behind a users ears to create an mask formation over a user's face. Doubled around the wearer's ankle it can be tuned to sense sounds from the user's steps so that it can trace every step taken by the wearer with a glowing light. When used under the bed covers it makes an entertaining night light. Held in a user's hand and waved through the air, the strobe features provide a light trace effect. Throw it into the air at night and watch the strobes. The sound sensitive features of the device can be tuned into video games and toys that make sound, it will then interact with that game or toy thereby enhancing the toy itself, also utilising the light guide 4.

The control unit 2 allows the light guide to be coupled to and uncoupled from the light guide 4. This allows the device to be manipulated so as to be attached to another toy or object, thus further enhancing its interaction and versatility. The device can also be tuned to a stereo system or karaoke machine by adjusting the sensitivity of each LED of the device. If adjusted correctly the device can be used to define the vocals from the beat, and or to define just the vocals or just to define each musical beat alone. When used in conjunction with karaoke or a stereo system the device can be used either on or as part of the machine itself or worn or held by a user in proximity to the machine. The device may be taken to a concert, event or dance party and to be worn or hold such that it reacts to sounds and produces a spectacular light show.

The inventor envisages that the apparatus of the present invention will appeal to a broad range of people. When marketed as a child's toy for 0 to 14 years olds the device can be used as an interactive light and sound toy. Children are becoming more and more technically advanced and with an apparatus embodying the present invention, the child can interact directly with the device providing an interactive and intelligent toy to keep themselves amused. The device can also be used to interact with the sounds made by the child's other toys, this effectively provides a means of enhancing those toys.

The device provides for a real time audio input resulting in a real time visual output to provide an audiovisual interactive toy. It is fun for children to use, providing an infinite variation for the child to experiment with the interaction between sound and light. The tuning dial/control puts the child in control, allowing them to adjust the sensitivity of the device so as to operate as desired and inturn allows them to observe interaction of the device with the sounds around. It effectively makes the child think: how does that work? and what else can I make it do? This provides education value teaching children not only about an interaction between light and sound but it can also be used to teach younger children about the mixing of colours together to make new colours. The device can be used by children of all ages for different purposes, it provides a toy which can be used to grow with the child. The device is also applicable to both boys and girls, each simply chooses their favourite colour.

The device of the present invention will also no doubt have appeal beyond its general appeal to children. Marketed to teens and adults, the device has great potential as a novelty. Many people of all ages will no doubt find the device irresistible simply as a novelty, this novelty factor can be realised in both the children's market and the market of adult “kids”. The device can be used and sold at events such as music concerts, festivals, shows, carnivals and the ever growing and thriving “dance scene”. Persons who attend these events often spend a large amount of time and money on their appearance often including eye-catching accessories in their outfits. Previously these people were limited to static or passive toys that have little or no interaction or entertainment value. The device of the present invention is an active toy that interacts with both the user and their surroundings to provide a light show for both the user and those around.

In one embodiment, the device utilises an optical cable having light guiding properties. The light guide will guide light along its length whilst allowing light to escape thereby creating a glowing effect around the band. One advantage of using an fibre optic fibre type cable is that it can be easily cut or trimmed to make the device into a custom fit. Another advantage is that it is flexible which allows a wide variety of shapes and configurations to be achieved. A further advantage of the invention is that it allows the user to join a number of bands together to form a larger band with varying configurations by utilising two or more control units.

It should be understood that the present invention may utilise a number of different illumination means which operate either individually or together. In one preferred embodiment, the illumination means consists of two LED's at each end, alternatively each of the first and second illumination means consist of a single LED. Where two LED's are provided side-by-side then there are even more colour combinations possible, this occurs as a result of adjacent LED's providing a further colour combination being a mix of colour from each of the LED's being simultaneously illuminated.

In another further embodiment, the device of the present invention has four LED's to provide combination with up to four different colours at one time giving even more potential to mix colours thereby making diverse colour combinations. Each device may also include one or more light guides allowing for a large number of different coupling configurations. If two control units are place together, each control unit having four different coloured LED's, then there is the potential to have eight different colours of light. Even further colour combinations can be provided where the LED's operate simultaneously to mix the light. The device of the present invention can be constructed so that each LED operates independently either individually or simultaneously at different pre-determined sound thresholds, each of which can be adjusted independently or as a whole. For example the user may adjust the device so that all LED's illuminate at the same sound threshold, alternatively, each one or more LED's may operate at a different sound threshold. Where a multiple number of LED's are provided, one or more of these LED's may be turned off to effectively provide a device effectively operating with fewer LED's. A wide number of permutations and combinations are possible. The device or bracelet may, in one still further embodiment, have a setting where the entire device senses sound at a fixed threshold (adjustable by the tuning dial or the like) such that the unit alternates between LED's. This can, for example, be done so that each LED operates in a pre-determined sequence. Where for example that there is a first, second, third and fourth LED. The first sound activates the first LED, the next sound then activates the second LED and so on until the fourth LED is activated. The program then re-activates the first LED. If the first, second, third and fourth LED's were red, blue, green and yellow respectively then each time you clap your hands the device would glow a different colour, scrolling through the colours red, blue, green, yellow and red again.

With two LED's then the possible combinations can be listed as:
(1) L1;
(2) L2;
(3) L1+L2 (creating a combination of both L1+L2).

With four LED's (L1, L2, L3 and L4) the possible combinations increase even further:
(1) L1; (L2, L3 and L4 off)
(2) L2; (L3, L1 and L4 off)
(3) L3; (L1, L2 and L4 off)
(4) L4; (L1, L2 and L3 off)
(5) L1+L2; (L3 and L4 off)
(6) L3+L4; (L1 and L2 off)
(7) L2+L4; (L1 and L3 off)
(8) L4+L1; (L2 and L3 off)
(9) L3+L2; (L1 and L4 off)
(10) L3+L1; (L2 and L4 off)
(11) L1+L2+L3; (L4 off)
(12) L2+L3+L4; (L1 off)
(13) L3+L4+L1; (L2 off)
(14) L4+L1+L2; (L3 off)
(15) L1+L2+L3+L4. (all on)

Where these illuminate simultaneously or independently then there are up to fifteen colour combinations. The device may, for example, be programmed to scroll through a number of the above combinations. For example:
(4)→(11)→(6)→(15)→(1)→repeat
or
(1)→(1)→(2)→(2)→(1)→(2)→(2)→repeat

Where four LED's are utilised in the present invention, it is anticipated that they will be grouped in two sets of two with each set located in close proximity or abutment with the light guide(s).

The light guide(s) may be of any suitable thickness. In one embodiment (having 2 LED's), the inventor envisages that the band will be approximately 5 mm in diameter. In another embodiment (having 4 LED's), the inventor envisages that the band will be double that diameter being approximately 10 mm. In a still further embodiment, two light guides may be used in a four LED's device.

The present invention may operate with any suitable power source. In a prototype built by the inventor, a battery powered power supply has proven particularly suitable. For example, three standard LR44 1.5 v alkaline button batteries running at a total of 4.5 volts can power the device. Using this battery, the inventor has been able to achieve a battery life of up to 30 hours continuous use. These batteries are inexpensive and available are a wide range of locations.

Where four LED's are utilised then further power may be required. A device of the present invention may be powered in any suitable manner.

The ability to disconnect and reconnect the device of the present invention makes it particularly versatile. This allows for the joining of two or more separate units thereby providing even more variation and potential for different colours and programs to interact as well as allowing many different modular coupling configurations.

It is also to be understood the device of the present invention may be permanently attached to a structure of the like, although the device also has particular appeal as a portable device that is lightweight and easy to carry.

Additionally, it should also be understood that the present invention encompasses a wide variety of devices to which the novelty device of the present invention are fitted. For example, an electronic device such as a portable radio, MP3 player and compact disc player may have the present invention installed to provide a light display to entertain the user. It is particularly preferred that the electronic device be a sound emitting electronic device to take advantage of the sound sensitive features of the present invention thereby allowing the interaction of sound and light.

When two or more devices are joined together and they operate on pre-programmed modes then there can be an appearance of interaction between the devices. For example, where each device produces a pre-set loop (whether the loops run at the same or different rates) then the loops from each device mix and combine to create a loop of their own.

It is to be understood that various alterations, additions and/or modifications may be made to the parts previously described without departing from the ambit of the invention.

1.-62. (canceled)

63. A novelty device including:
(a) a light guide which channels light whilst allowing a portion of the light to be emitted along at least part of the length of the light guide;
(b) detection means for detecting sound; and
(c) illumination means for illuminating the light guide;
wherein the illumination means operates to illuminate at least part of the light guide based on the detection of sound by the detection means.

64. A novelty device according to claim 63, wherein the light guide is side emissive.

65. A novelty device according to claim 63, wherein the illumination means operates to illuminate the light guide when sound is detected above or below a pre-determined volume level, frequency threshold or within a predetermined range.

66. A novelty device according to claim 65, further including means for adjusting the volume level, frequency threshold or pre-determined range.

67. A novelty device according to claim 63, wherein the illumination means illuminates the light guide at an intensity dependent on volume level or frequency of sound detected.

68. A novelty device according to claim 67, further including means for adjusting the illumination intensity for a pre-determined volume level, frequency threshold or pre-determined range.

69. A novelty device according to claim 67, wherein the light guide is illuminated at an intensity that is proportional to the volume level or frequency of sound detected by the detection means.

70. A novelty device according to claim 67, wherein intensity of the illumination is related to the degree to which the volume level or frequency of a detected sound exceeds a threshold value.

71. A novelty device according to claim 70, including means for adjusting the sensitivity of the detection means.

72. A novelty device according to claim 71, wherein the means for adjusting the sensitivity of the detection means is automatic.

73. A novelty device according to claim 63, wherein the illumination means includes one or more light emitting diodes.

74. A novelty device according to claim 63, wherein the illumination means includes:
(a) two light emitting diodes with one light emitting diode in close proximity to an end of the light guide; or
(b) four light emitting diodes with two light emitting diodes in close proximity to an end of the light guide.

75. A novelty device according to claim 73,wherein the illumination means is capable of illuminating the light guide with light of at least two different colours.

76. A novelty device according to claim 75, wherein the illumination means illuminates one part of the light guide in a first colour and a second part of the light guide in a second colour different from the first colour.

77. A novelty device according to claim 76, wherein the light guide is illuminated in the first colour and the second colour simultaneously to provide a part of the light guide which is illuminated in a colour formed by a mixture of the first and second colours.

78. A novelty device according to claim 75, wherein the light guide is illuminated in a plurality of colours simultaneously to provide a part of the light guide which is illuminated in a colour formed by a mixture of colours.

79. A novelty device according to claim 63, wherein the illumination means includes a first illumination means and a second illumination means and wherein, the first illumination means operates upon detection of sound at a first sound characteristic and the second illumination means operates upon detection of sound at a second sound characteristic.

80. A novelty device according to claim 79, wherein each of the first and second sound characteristic are one of:
(a) a pre-determined volume;
(b) a pre-determined frequency;
(c) a range of pre-determined volumes; and
(d) a range of pre-determined frequencies.

81. A novelty device according to claim 63, including two or more illumination means, each illumination means operating upon detection of sound above, below or at a pre-determined threshold level, wherein the illumination means operate:
(a) independently of each other in sequence; or
(b) simultaneously
(c) in sequence; or
(d) according to a pre-programmed sequence.

82. A novelty device according to claim 81, further including means for adjusting the pre-determined threshold level.

83. A novelty device according to claim 63, wherein the light guide is illuminated at a first intensity when sound is detected at a first sound level and illuminated at a second intensity when sound is detected at a second sound level, wherein when the second sound level is less than the first sound level then the first intensity is greater than the second intensity.

84. A novelty device according to claim 63, wherein the novelty device is a personal adornment device.

85. A novelty device according to claim 63, including a control unit for housing the detection means and the illumination means, wherein the control unit is coupled to at least one end of the light guide.

86. A novelty device according to claim 85, including more than one control unit, each control unit being coupled to more than one light guide.

87. A novelty device according to claim 85, including a plurality of control units interconnected via a plurality of light guides to form a design pattern.

88. A novelty device according to claim 85, wherein the control unit is releasably coupled to the light guide.

89. A novelty device according to claim 85, wherein the light guide is arranged in a circular or figure of eight configuration.

90. A novelty device according to claim 85, wherein the control unit includes:
(a) coupling means for releasably coupling the control unit to two or more light guides;
(b) illumination means for illuminating the two or more light guides.

91. A novelty device according to claim 63, wherein upon detection of sound, the illumination means operates to illuminate the light guide according to a pre-set program.

92. A novelty device, including:
(a) a light guide which channels light whilst allowing a portion of the light to be emitted along at least part of the length of the light guide;
(b) a control unit coupled to the light guide, the control unit including illumination means for illuminating, wherein the illumination means directs light into the light guide according to one or more pre-determined programs.

93. A novelty device according to claim 92, wherein the light guide is side emissive.

94. A novelty device according to claim 92, wherein the illumination means is capable of illuminating the light guide with light of at least two different colours.

95. A novelty device according to claim 92, wherein the illumination means illuminates one part of the light guide in a first colour and a second part of the light guide in a second colour different from the first colour.

96. A novelty device according to claim 92, wherein the light guide is illuminated in the first colour and the second colour simultaneously to provide a part of the light guide which is illuminated in a colour formed by a mixture of the first and second colours.

97. A novelty device according to claim 92, wherein the light guide is illuminated in a plurality of colours simultaneously to provide a part of the light guide which is illuminated in a colour formed by a mixture of colours.

98. A novelty device according to claim 92, including more than one control unit, each control unit being coupled to more than one light guide.

99. A novelty device according to claim 92, including a plurality of control units interconnected via a plurality of light guides to form a design pattern.

100. A novelty device according to claim 92, wherein the control unit is releasably coupled to the light guide.

101. A novelty device according to claim 92, wherein the light guides are arranged in a circular or figure of eight configuration.

102. A novelty device according to claim 92, wherein the control unit includes:
(a) coupling means for releasably coupling the control unit to more than one light guide;
(b) illumination means for illuminating the more than one light guides.

103. A novelty device according to claim 92, wherein the novelty device is a personal adornment device.

104. A light emitting device, including:
(a) a light guide which channels light whilst allowing a portion of the light to be emitted along at least part of the length of the light guide, the light guide being configured to be fitted to a sound emitting electronic device; and
(b) illumination means for illuminating at least part of the light guide in response to sound emitted from the sound emitting electronic device.
